(19) United States
(12) Patent Application Publication
(10) Pub. No.: US 2006/0196029 A1
(43) Pub. Date: Sep. 7, 2006

(54) Device for extracting and pressing in a wheel bearing that is closed in the rear

(76) Inventor: Horst Klann, Villingen-Schwenningen (DE)

Correspondence Address: McGLEW AND TUTTLE, P.C.;Counselors at Law, SCARBOROUGH STATION, SCARBOROUGH, NY, 10510-9227, US

(21) Appl. No.: 11/367,799

(22) Filed: Mar. 3, 2006

(30) Foreign Application Priority Data
Mar. 4, 2005 (DE) 20 2005 003 450.9

(51) Int. Cl. B23P 19/04

(52) U.S. Cl. 29/260

(57) ABSTRACT

A device is provided for extracting and pressing in a wheel bearing, which can be accommodated in a bearing bore of a bearing housing of an axle body and via which a wheel hub is rotatably mounted in the bearing housing. The device includes a pressing means as well as a pressing plate (65), which can be arranged with a support flange (84, 85) between the wheel hub and the axle body, wherein the axle body is provided with a plurality of bearing eyes, which are used to mount additional axle components or a caliper. To make it possible to replace closed wheel flange hubs and/or closed wheel bearings in a simple and reliable manner, provisions are made according to the present invention for the pressing plate (65) to form a guide plate (68), which has an approximately semicircular opening (80), which is radially limited by the support flange (84), and for the guide plate (68) with its support flange (84) to be able to be pushed into an intermediate space between the wheel hub flange of the wheel hub and the bearing housing of the axle body such that the support flange (84) is supported on the rear side at the wheel hub flange during the extraction operation and axially at the wheel bearing during the pressing-in operation.

### CROSS REFERENCE TO RELATED APPLICATIONS

This application claims the benefit of priority under 35 U.S.C. § 119 of German Patent Application DE 20 2005 003 450.9 filed Mar. 4, 2005, the entire contents of which are incorporated herein by reference.

### FIELD OF THE INVENTION

The present invention pertains to a device for extracting and pressing in a wheel bearing, which can be accommodated in a bearing bore of a bearing housing of an axle body, via which a wheel hub is mounted rotatably in the bearing housing, comprising a pressing means as well as a pressing plate, which can be arranged with a support flange between the wheel hub and the axle body, wherein the axle body is provided with a plurality of bearing eyes, which are used to mount additional axle components or a caliper.

### BACKGROUND OF THE INVENTION

Devices for extracting and/or pressing in wheel bearings have been known for a long time. The documents DE 201 06 519.3, DE 89 08 237.0, DE 37 30 017 C1, as well as DE 35 30 983 C1 shall be cited here as examples.

It is common to all these devices according to the documents cited that these have a plurality of pressing plates or centering disks of different shapes in order to make it possible to carry out different mounting and/or removal operations on axle bodies of different shapes to replace wheel flange hubs and/or wheel bearings. Reference is being made in this respect to the documents.

It is known, for example, from DE 93 15 919.6 U1 that a so-called perforated disk, which can be brought into contact with the wheel flange of the wheel flange hub on the outside, can be used for mounting and removal. The wheel flange hub as well as the wheel bearing of an axle component of a motor vehicle can be replaced with the device by means of a suitable pressing device, which is designed as a spindle drive in the subject of DE 93 15 919.6 U1, as well as of various pressing plates, centering disks or support plates, which are supported at the wheel bearing or also at the axle component.

For example, DE 89 08 237.0 U1 shows, especially for replacing the wheel flange hub, a support plate, which is called a support yoke and has a U-shaped design. This support plate has a U-shaped recess, with which the support plate can be introduced between the wheel flange of the wheel flange hub and the axle component or the bearing housing of the axle component, so that this support plate is axially supported at the bearing housing during the extraction of the wheel flange hub from the corresponding wheel bearing. A draw spindle, which passes axially through the wheel hub, is used for pressing out here as well.

Provisions are usually made in case of the conventional design of such axle components with wheel flange hubs and wheel bearings for arranging a brake disk on the outside on the wheel flange, which brake disk is consequently located, in the completely mounted state, between the wheel flange and the wheel of the motor vehicle, which is to be mounted later. Furthermore, such axle components with radially projecting mounting eyes are provided for a caliper, at which a caliper can be stationarily mounted in the circumferential area of the brake disk.

A device of the type of this class, which is intended especially for pressing out and pressing in wheel flange hubs as well as wheel bearings in the case of a brake disk “located on the inside,” is known from DE 202 06 000.4 U1.

This device has, for this purpose, a support plate, which can be stationarily and detachably connected to the mounting eyes or the bearing eyes at a spaced location from the axle body on the side of the axle body located axially opposite the wheel flange. Furthermore, the support plate is provided with a support element, with which the support plate can be caused to stationarily mesh with a linkage lever or another, radially projecting component of the axle body. This support plate is used as an abutment for a pressing device, which is formed from a hydraulic cylinder. This hydraulic cylinder can be stationarily connected to the wheel hub flange via holding bolts. For extraction and pressing in, the hydraulic cylinder has a pressing rod, which passes axially through the wheel hub during the pressing operation and is axially supported at the support plate.

Thus, the performance of repairs cannot be performed with the devices in the case of axle designs in which the wheel hub or the wheel bearing is closed. Consequently, the pressing rod of a hydraulic cylinder or a draw spindle cannot be passed through the wheel hub in such axle designs, so that the pressing rod or draw spindle cannot be correspondingly supported axially on the opposite side of the wheel bearing. In particular, the pressing in of the wheel bearing into the bearing housing would be possible only by direct pressure on the wheel hub, if the prior-art devices were able to be brought into contact with the axle body at all, as a result of which there would be a risk of damage to the wheel bearing.

### SUMMARY OF THE INVENTION

Consequently, the basic object of the present invention is to design a device of the type of this class such that the replacement of closed wheel flange hubs and/or closed wheel bearings can be carried out in a simple and reliable manner.

The object is accomplished according to the present invention by the pressing plate forming a guide plate, which has an approximately semicircular opening, which is radially limited by the support flange, and by the guide plate with its support flange being able to be pushed into an intermediate space between the wheel hub flange of the wheel hub and the bearing housing of the axle body such that the support flange is supported on the rear side at the wheel hub flange during the extraction operation and axially at the wheel bearing during the pressing-in operation.

The design according to the present invention makes available a device with which it is possible in a simple and reliable manner to replace closed wheel hubs or even closed wheel bearings. The guide plate may have a U-shaped design, the support flange extending over about 180° and being able to be caused to mesh over this angle range with the wheel hub flange on the rear side, on the one hand, and the outer bearing ring of the wheel bearing, on the other hand..

The radial dimensions of the opening of the pressing plate or the guide plate with its support flange are selected for this purpose such that the support flange extends radially inwardly up to the “outer ring” of the wheel bearing in the state in which it is inserted between the wheel hub and the bearing housing. Thus, it can be brought into pressing contact with the wheel bearing especially to press in the wheel bearing, so that the wheel bearing can be pressed into the bearing housing without being damaged at all. The extraction is carried out by pulling the pressing plate or the guide plate with its support flange or the guide plate itself directly, depending on the design of the wheel hub, at the radially projecting wheel hub flange.

Provisions may be for the support flange of the guide plate to be provided, in the area of its radial inner edge, with an axially projecting support web, with which the wheel bearing can be pressed into the bearing housing in a recessed manner. The thickness of the support plate with its support web is adapted to the width of the intermediate space between the wheel hub flange and the bearing housing such that after the wheel bearing has been pressed in, the guide plate with its support flange can be moved against the direction of pressing in in the direction of the wheel hub flange and can be removed from the intermediate space.

To increase the stability of the pressing plate, a holding plate, which is detachably fastened to the guide plate, can be associated with the guide plate. This holding plate likewise has an approximately semicircular opening, which is radially limited by a support flange. The holding plate can be pushed with the support flange into the intermediate space between the wheel hub flange of the wheel hub and the bearing housing of the axle body such that the support flange is supported on the rear side at the wheel hub flange during the extraction operation and axially at the wheel bearing during the pressing-in operation, i.e., the wheel hub is mounted completely during the operation before the guide plate and the holding plate. To press in the wheel bearing, the wheel hub with the wheel flange hub is first caused to mesh with the guide plate, so that the guide plate with its support flange is arranged between the outer bearing ring of the wheel bearing and the wheel hub flange. The holding plate is subsequently connected stationarily to the guide plate, for example, by means of screw connections, so that the holding plate with its support flange also comes to lie between the outer bearing ring of the wheel bearing and the wheel hub flange. It is thus possible to apply extremely strong pressing forces to the bearing ring during pressing in, so that tilting or the like of the wheel bearing during pressing in is ruled out with certainty.

The support flange of the holding plate may also be provided with an axially projecting support web in the area of its radial inner edge, so that the wheel bearing can be pressed into the bearing housing in a recessed manner with the holding plate as well. The design of the support web corresponds here to the design of the support web of the guide plate.

To apply the necessary pulling forces or pressing forces, provisions are, furthermore, made for the pressing means to have a support plate, which can be stationarily attached to the bearing eyes of the axle body via support rods and for the pressing means to have a pressing rod, which can be axially adjusted in relation to the support plate and can be coupled with the pressing plate in an axially stationary manner. When the pressing means is activated, the pressing plate moves relative to the pressing means and relative to the support plate and thus also relative to the axle body in the axial direction, so that, depending on the direction of activation of the pressing means, it is possible, as desired, to pull the wheel hub flange or to push the wheel bearing. Due to this design, the device according to the present invention can also be used directly at the vehicle. If such a use at the vehicle is not desired, the pressing plate may also be used in connection with a stationary press, which can be correspondingly brought into contact with the axle body.

Thus, provisions may be made for providing a coupling bridge for the axial adjustment of the pressing plate, which said coupling bridge is coupled with the pressing rod in an axially stationary manner during the pressing operation. This coupling bridge consequently moves together with the pressing rod, so that the pressing plate is also inevitably moved in one or the other pulling direction or pressing direction. In a simple form, this coupling bridge may have an approximately beam-shaped design, whose length is greater than the diameter of the wheel hub flange, so that the coupling bridge can be mechanically coupled with the pressing plate, which is arranged “behind” the wheel hub flange during the pressing operation, in a simple manner. The pressing plate now projects over the wheel hub flange at least in some areas in the radial direction. Instead of being beam-shaped, the coupling bridge may also have the shape of a plate or another suitable shape.

Provisions may be made for the pressing rod to be part of a hydraulic cylinder, which replaceably meshes with the support plate in an axially stationary manner, and for the pressing rod to have an adjusting thread, via which the pressing rod is mounted in an axially adjustable pressing piston of the hydraulic cylinder in an axially adjustable manner. Due to this design, extremely strong pressing forces can be applied with the device according to the present invention. Furthermore, the pressing means can be adapted to different dimensions of the axle body due to the axial adjustability of the pressing rod in the pressing piston of the hydraulic cylinder.

Due to the design according to one aspect of the invention, the pressing rod can be coupled with the coupling bridge in an extremely simple manner. Provisions are made for this purpose for the pressing rod to be able to be brought into pulling connection by means of its adjusting thread with the coupling bridge to press out the wheel hub together with the wheel bearing. The coupling bridge itself may be provided for this pulling connection with an internal thread, into which the adjusting thread of the pressing rod can be screwed. On the other hand, provisions may also be made for the pressing rod being adjusted through a corresponding through hole of the coupling bridge and for a tension nut to be screwed on the adjusting thread on the “rear side.”

If an internal thread is provided, provisions may be made according to one aspect of the invention for this internal thread of the coupling bridge to be part of a pulling sleeve, which is arranged in a hollow of the coupling bridge and is supported axially at an inner front ring wall of the hollow during the pressing-out operation to establish the pulling connection. The pressing rod can be screwed into the internal thread in an extremely simple manner due to this design without an additional axial adjustment of the pressing piston being necessary.

Furthermore, provisions may be made for this purpose according to one aspect of the invention for the pulling sleeve to be axially adjustable and to be held nonrotatably by means of coupling pins extending into the hollow of the coupling bridge, and for the coupling pins to radially mesh with adjusting slots of the pulling sleeve. Due to the axial adjustability, the pulling sleeve with the threads of its internal thread can be set to the threads of the adjusting thread of the pressing rod.

Due to the axial compression spring provided according to one aspect of the invention, automatic axial alignment of the threads of the internal thread of the pulling sleeve with the threads of the pressing rod is achieved during the axial adjustment of the pressing rod with its adjusting thread. The axial compression spring is axially supported now axially at a closing cover, which is screwed detachably on the coupling bridge on the outside in the area of the hollow.

Due to the pressing head provided in the end area of the pressing rod, the pressing rod can be brought into pressing connection with the coupling bridge in a simple manner to press in the wheel bearing.

This pressing head may be provided, with a hexagon insert bit, so that the pressing rod can be axially adjusted in the pressing piston of the hydraulic cylinder in a simple manner.

To stationarily couple the pressing plate comprising the guide plate and the holding plate with the coupling bridge, spacer sleeves as well as connection screws are provided. The guide plate and the holding plate are preferably screwed to one another in the state in which they are attached to the wheel hub.

The attaching of the wheel hub together with the wheel bearing for pressing in is considerably simplified. Provisions are made for this purpose for the pressing plate to be provided with two guide holes, via which the pressing plate is guided concentrically with the bearing housing and the wheel hub at two of the support rods in an axially adjustable manner. For mounting, the wheel hub is inserted into the guide plate and displaced in relation to the bearing housing until the wheel bearing seated on the wheel flange hub is in contact with the bearing bore of the bearing housing. Subsequently or before, the holding plate may be attached to the wheel hub and screwed to the guide plate. Due to this guiding of the guide plate at the support rods, which are stationarily connected to the axle body, the wheel hub is thus aligned automatically concentrically with the bearing bore together with the wheel bearing, so that tilting is ruled out with certainty during the subsequent pressing-in operation.

An inexpensive pressing means with low weight is made available by the design, as a result of which handling is considerably facilitated. Provisions are made for this purpose for the hydraulic cylinder to be designed as a single-acting tubular piston cylinder and is provided at its two axial ends with coupling elements, with which the hydraulic cylinder can be caused to mesh with the support plate in different orientations for applying pulling or pressing forces as desired.

Coupling threads or even quick-acting closures may also be provided as coupling elements here. Such a quick-acting closure may be a coupling cylinder, which can be inserted into a corresponding mounting hole of the support plate and which is secured in the mounting hole by means of transversely extending guide pins or by means of U-shaped locking plates that can be inserted into a radial groove of the coupling cylinder.

The device according to the present invention is suitable for extracting and pressing in wheel bearings, which are secured in the bearing housing by means of conventional circlips or also by means of a so-called locking ring. A locking ring is pressed snugly on the outer ring of the bearing and meshes with a circumferential groove of the bearing bore of the bearing housing with locking tabs projecting radially in a spring-loaded manner. Such locking rings have been used recently because fully automatic assembly of the wheel hub together with the wheel bearing in the bearing housing is thus made possible on an assembly line.

An exemplary embodiment of the present invention will be explained in greater detail below on the basis of the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded perspective view of a pressing means of the device according to the present invention;

FIG. 2 is an exploded perspective view of a coupling device together with a pressing plate;

FIG. 3 is an exploded perspective view of an axle body together with a wheel hub and a wheel bearing;

FIG. 4 is a side view IV of the axle body with the wheel hub mounted;

FIG. 5 is a perspective view of the axle body with the mounted wheel hub and the pressing plate from FIG. 2;

FIG. 6 is the view from FIG. 5 with the pressing plate arranged between the wheel hub and the axle body;

FIG. 7 is a perspective view of an axle body with the pressing means mounted thereon as well as with a pressing plate meshing with the wheel hub;

FIG. 8 is a perspective cut-away view of a part of the pressing means as well as of a coupling bridge coupled with the pressing plate;

FIG. 9 is a cross section through the coupling bridge, into which a pulling sleeve is inserted in an axially adjustable manner;

FIG. 10 is a perspective view of the complete device according to the present invention attached to the axle body and to the wheel hub immediately after the pressing out of the wheel bearing;

FIG. 11 is a perspective view of the pressing device attached to the axle body together with the guide plate attached to the wheel hub before the pressing-in operation;

FIG. 12 is a section XII-XII in FIG. 11 of the device according to the present invention immediately before the pressing-in operation; and

FIG. 13 is the sectional view from FIG. 12 after the wheel bearing has been pressed completely into the bearing housing of the axle body.

### DESCRIPTION OF THE PREFERRED EMBODIMENTS

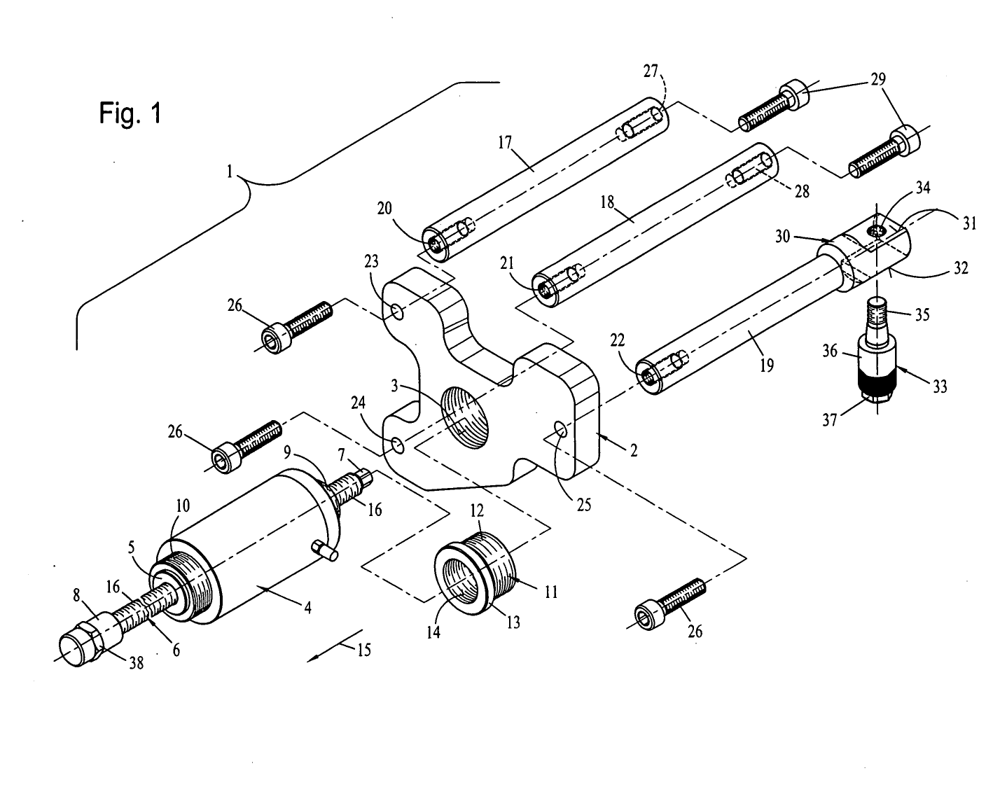

Referring to the drawings in particular, FIG. 1 shows a pressing means 1 of the device according to the present invention. This pressing means 1 comprises in this exemplary embodiment a support plate 2, which has a central internal thread 3. This internal thread 3 is used to replaceably mount a hydraulic cylinder 4, which is designed as a so-called tubular piston cylinder and has an axially movable pressing piston 5. The pressing piston 5 is provided with an axially adjustable pressing rod 6, which is provided with a drive hexagon 7 in one of its end areas. Axially opposite this drive hexagon 7, the pressing rod 6 has a pressing head 8, which is radially expanded and is provided with wrench surfaces 38.

To couple the hydraulic cylinder 4 with the support plate 2, this hydraulic cylinder has, for example, a respective coupling thread 9 and 10 each in its two end areas.

Instead of such coupling threads, it is also possible to provide as coupling elements coupling cylinders acting as a quick-acting closure, which can be inserted into a corresponding mounting hole of the support plate. To secure the coupling cylinder in the mounting hole, locking pins, which extend radially or tangentially in relation to the coupling cylinder and extend into the mounting hole, may be provided. The coupling cylinder may also pass completely through the mounting hole in the inserted state and be provided with a circumferential groove, into which, for example, a U-shaped locking plate may be pushed to lock the coupling cylinder.

Since the rear coupling thread 9 has a smaller diameter in this exemplary embodiment than the internal thread 3 of the support plate 2, an adapter 11, which has an external thread 12, with which the adapter 11 can be screwed into the internal thread 3 of the support plate 2, is provided for coupling the coupling thread 9 of the hydraulic cylinder 4 with the internal thread 3 of the support plate 2. To limit the depth of screwing in, the adapter 11 has a radially expanding stop collar 13 in its front end area. To screw in the coupling thread 9 of the hydraulic cylinder 4, the adapter 11 is provided with a corresponding internal thread 14.

It is easy to imagine that the hydraulic cylinder 4 can be caused to stationarily and replaceably mesh with the support plate 2 via the adapter 11. The hydraulic cylinder 4 designed as a tubular piston cylinder is a single-acting cylinder, so that when it is activated, the pressing piston 5 is adjusted in the direction of arrow 15 if the hydraulic cylinder 4 is oriented as shown in FIG. 1. At the same time, adjustment of the pressing rod 6 in the direction of arrow 15 is brought about as well, so that corresponding pulling forces can be applied with this pressing rod.

The pressing rod 6 is designed as a threaded rod in this exemplary embodiment and correspondingly has an adjusting thread 16, via which the pressing rod 6 can be adjusted axially variably relative to the pressing piston 5. In this exemplary embodiment of the pressing rod 6, the adjusting thread 16 extends over the entire axial length thereof between the drive hexagon 7 as well as the radially expanded pressing head 8.

Furthermore, it can be recognized from FIG. 1 that a total of three support rods 17, 18 and 19 are provided in this exemplary embodiment. Each of these pressing rods 17, 18 and 19 has a respective internal thread 20, 21 and 22 on the front side toward the support plate 2, via which respective support rods 17, 18 and 19 can be connected to the support plate 2 in a stationary and detachable manner. The support plate 2 is correspondingly provided with three through holes 23, 24 and 25 for this purpose. Corresponding mounting screws 26 can be passed through these through holes 23, 24 and 25 and can be caused to correspondingly mesh with the internal threads 20, 21 and 22 of the respective support rods 17, 18 and 19 associated with them.

As an alternative to this design, the support rods may also be provided with axially projecting threaded pins, which can be passed through the through holes 23, 24 and 25 of the support plate 2 and can be attached to the support plate 2 by means of corresponding mounting nuts.

Furthermore, it can be recognized that the two cylindrical support rods 17 and 18 are provided on the front side, in their end area located opposite the internal threads 20 and 21, with a respective second internal thread 27 and 28 each, into which a fastening screw 29 each can be screwed. By means of these internal threads 27 and 28 as well as the fastening screws 29, the two support rods 17 and 18 can be connected to the mounting flange of an axle body in a stationary manner. This will be explained in greater detail below.

As an alternative, axially projecting threaded pins, which can either be screwed into corresponding threads of the bearing eyes of an axle body or can be fastened to the bearing eyes by means of mounting nuts, may be provided here as well.

In its end area located opposite the internal thread 22, the third support rod 19 is provided with a mounting head 30, which has two mounting surfaces 31 and 32, which extend in parallel to one another, in this exemplary embodiment. Depending on the orientation of the support rod 19, the latter can be attached with its mounting head 30, with one of its two mounting surfaces 31 or 32, as desired, to the bearing eye of a linkage lever of an axle body, as will be explained in greater detail below.

To mount the mounting head 30 stationarily at this bearing eye of the linkage IS lever, a locking screw 33, which can be passed through the bearing eye of the linkage lever and is provided with a corresponding threaded pin 35 for being screwed into an internal thread 34 of the mounting head 30, is provided in this exemplary embodiment. In its end area located opposite the threaded pin 35, the locking screw 33 has a radially expanded cylindrical section 36, which is used to screw the locking screw 33 manually into the internal thread 34 of the mounting head 30. To make it possible to tighten the locking screw 33, a drive hexagon 37, via which the locking screw 33 can be tightened by means of a suitable wrench, is provided in the axial extension of the cylindrical section 36.

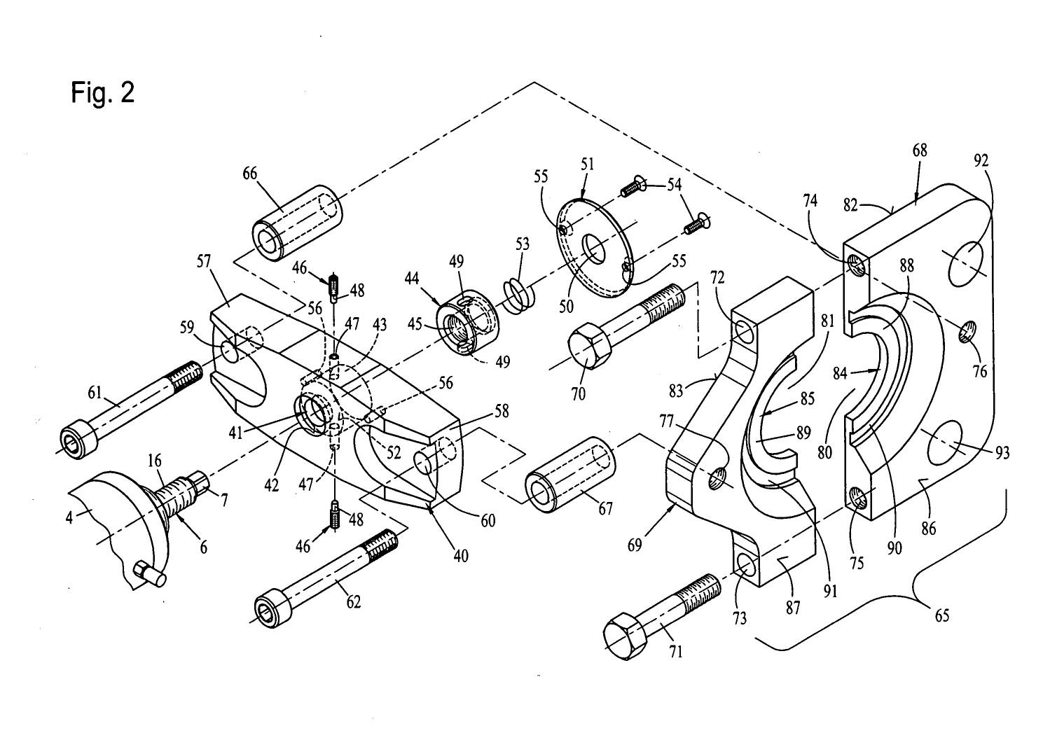

The pressing rod 6 can be brought into pulling or pushing connection with a coupling bridge 40 as desired, depending on the orientation of the hydraulic cylinder 4. A perspective view of this coupling bridge 40 is shown in FIG. 2. It can be recognized that this coupling bridge has a central through hole 41, which is provided with a radially expanded hollow 42 toward the pressing rod 6. With this hollow 42, the coupling bridge 40 can be brought into pressing connection with the pressing head 8 of the pressing rod 6 from FIG. 1.

Furthermore, it can be recognized from the broken lines in FIG. 2 that the through hole 41 is provided, on its side located axially opposite the hollow 42, with a second, radially expanded hollow 43, which is larger than the hollow 42. This hollow 43 is deeper in the axial length than the front hollow 42 and is used to receive a pulling sleeve 44.

This pulling sleeve 44 can be inserted into the hollow 43 with a small clearance and in an axially adjustable manner. For coupling with the adjusting thread 16 of the pressing rod 6, the pulling sleeve 44 has a corresponding internal thread 45. To hold the pulling sleeve 44 nonrotatably in the hollow 43, two stud screws 46 are provided in this exemplary embodiment, which can be screwed through corresponding through threads 47, which open into the hollow 43 and extend radially to the hollow 43.

The stud screws 46 have a coupling pin 48 each, with which the stud screws 46 can be caused to mesh with longitudinal slots 49 arranged correspondingly in the pulling sleeve 44. The axial extension of these longitudinal slots 49 is limited and these longitudinal slots thus limit the maximum path of adjustment of the pulling sleeve 44 that is axially possible in the hollow 43. A closing cover 51, which is provided with a through hole 50, is provided for holding the pulling sleeve 44 in the hollow 43.

The through hole 50 is used during the operation to pass through the pressing rod 6 with its drive hexagon 7 in the state in which it is screwed into the pulling sleeve 44. To push the pulling sleeve 44 elastically against the inner front ring wall 52 of the hollow 43, a corresponding axial compression spring 53 is provided. Due to this elastic, axially displaceable and nonrotatable mounting of the pulling sleeve 44 in the hollow 43 of the coupling bridge 40, the adjusting thread 16 of the pressing rod 6 can be screwed into the internal thread 45 of the pulling sleeve 44 in a simple manner. In particular, the pressing rod 6 with its adjusting thread 16 does not need to be set axially to the axial position of the pulling sleeve 44 with its internal thread 45 for this purpose because of the axial displaceability of the pulling sleeve 44.

To mount the closing cover 51 stationarily, two mounting screws 54 are provided in this exemplary embodiment, which can be passed through two through holes 55 of the closing cover 51 and can be correspondingly screwed into two internal threads 56 of the coupling bridge 40.

As is apparent from FIG. 2, the coupling bridge 40 has a beam-shaped design in this exemplary embodiment and extends, starting from its central through hole 41, laterally symmetrically in relation to the through hole 41. In its two lateral end areas 57 and 58, the coupling bridge 40 is provided with a through hole 59 and 60, respectively, through which a connecting screw 61 and 62 each can be passed.

A pressing plate 65 can be stationarily connected to the coupling bridge 40 by means of these connecting screws 61 and 62. To set a defined axial distance between the pressing plate 65 and the coupling bridge 40, two spacer sleeves 66 and 67 are provided in this exemplary embodiment, through which the two connecting screws 61 and 62 can be passed.

Instead of this coupling bridge 40 as designed in this example, it is also possible to provide a coupling means of another type, which is accommodated between the support rods 17, 18 and 19 and makes it possible to couple the pressing rod 6 with the pressing plate 65.

The pressing plate 65 comprises a guide plate 68 and a holding plate 69 that can be connected thereto in this exemplary embodiment. Two connecting screws 70 and 71, which can be passed through corresponding through holes 72 and 73 of the holding plate 69 and can be screwed into two correspondingly associated internal threads 74 and 75 of the guide plate 68, respectively, as this is shown as an example in FIG. 2, are provided in this exemplary embodiment for the detachable connection of the guide plate 68 and the holding plate 69.

The guide plate 68 and the holding plate 69 have a corresponding internal thread 76 and 77, respectively, to fasten the coupling bridge 40 by means of the two connecting screws 61 and 62.

Furthermore, it can be recognized from FIG. 2 that the guide plate 68 has an approximately semicircular opening 80 toward the holding plate 69. Likewise, the holding plate 69 is likewise provided with a semicircular opening 81 toward the guide plate 68. In the state in which the holding plate 69 is mounted on the guide plate 68, the two openings 80 and 81 form a round opening.

Furthermore, it can be recognized from FIG. 2 that the guide plate 68 and the holding plate 69 have a smaller thickness in the radial areas surrounding their respective openings 80 and 81. The guide plate 68 and the holding plate 69 form a flat support surface 82 and 83, respectively, toward the coupling bridge 40, and the guide plate 68 and the holding plate 69 are supported via these respective support surfaces on the rear side at the wheel hub flange of a wheel hub during the extraction of a wheel bearing.

In this exemplary embodiment, the radial areas surrounding the two semicircular or U-shaped openings 80 and 81 form a type of support flange 84 and 85, respectively, which are provided, in the radially inner area, with a respective ring-shaped support web 88 and 89, which project axially in relation to the respective front face 86 and 87 of the guide plate 68 and the holding plate 69, respectively. The two support webs 88 and 89 are correspondingly joined by respective depressions 90 and 91 extending in a circular arc-shaped pattern in the radially outwardly direction.

During operation, i.e., in the state of the guide plate 68 and the holding plate 69 in which these plates are attached between a wheel hub and the wheel bearing arranged on the wheel hub, the two support webs 88 and 89 are axially supported at the outer bearing ring of a wheel bearing. Due to the setback arrangement of the depressions 90 and 91, a wheel bearing can thus be pressed into the bearing housing of an axle body in a recessed manner until the guide plate 68 and the holding plate 69 with their respective depressions 90 and 91 are flatly in contact with the outer front ring surface of the bearing housing.

To guide the pressing plate 65 in a defined manner, the guide plate 68 has two through holes 92 and 93, via which the guide plate 68 and thus the holding plate 69, mounted snugly on the guide plate 68, are guided at the two support rods 17 and 18 in an axially adjustable manner, as this will explained in greater detail below.

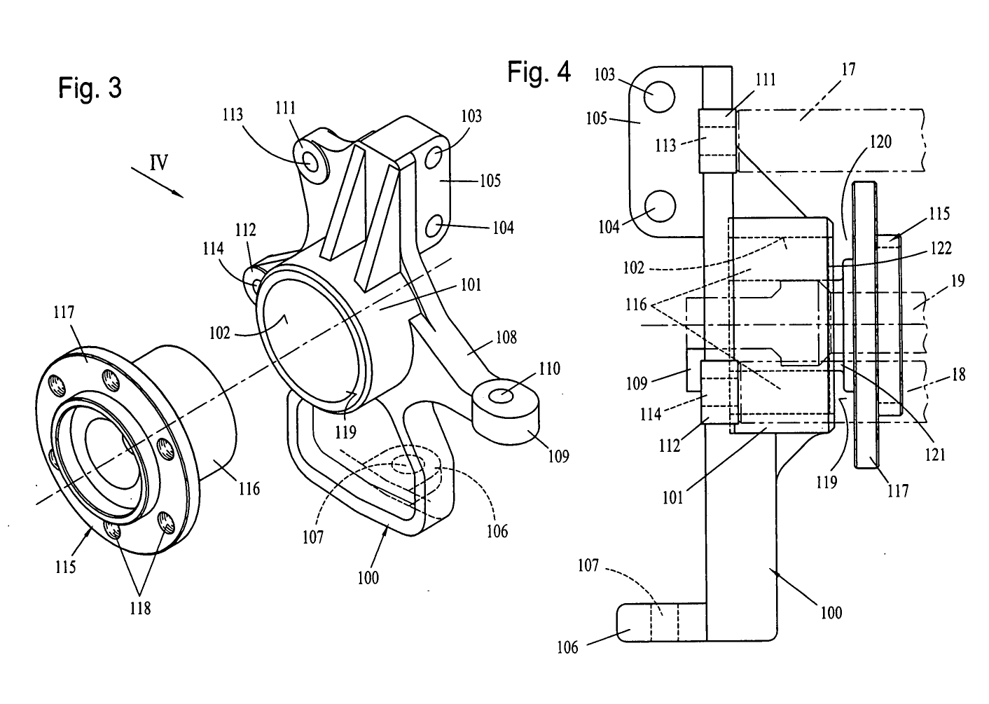

FIG. 3 schematically shows an axle body 100 as it is used, for example, in motor vehicles. This axle body 100 has a central bearing housing 101, which forms a central bearing bore 102. To mount the axle body 100 on other axle components, a bearing block 105, provided with two cross holes 103 and 104, is provided in the upper end area of the axle body 100 in this exemplary embodiment. In the lower end area of the axle body 100, the latter has a bearing web 106 arranged on the rear side with a corresponding mounting hole 107, via which the axle body 100 can be coupled, for example, with the support joint of a suspension arm of a motor vehicle axle. The bearing block 105 is usually used to couple the axle body 100 with a spring strut.

Furthermore, it can be recognized from FIG. 3 that the axle body 100 has a laterally projecting control sleeve strut 108, which is provided with a bearing eye 109 at its outer end. This bearing eye 109 has a corresponding through hole 110 in this exemplary embodiment for coupling with additional axle components of a motor vehicle axle.

Furthermore, it can be recognized from FIG. 3 that the axle body 100 is provided, on its side located opposite the control sleeve lever 108, with two mounting eyes 111 and 112, which are in turn provided with corresponding mounting holes 1 13 and 1 14. Such mounting eyes 111 and 112, as they are shown as an example in FIG. 3, are known to be used to mount a caliper on the axle body 100.

The pressing means 1 from FIG. 1 can be mounted stationarily on the axle body via its two support rods 17 and 18 with these mounting eyes 111, 112. The third support rod 19 with its mounting head 30 can in turn be coupled stationarily with the bearing eye 109 of the control sleeve lever 108. The pressing means 1 with its support plate 2 as well as with the hydraulic cylinder 4 can thus be mounted stationarily on the axle body 100 and the bearing eyes 109, 111 and 112 of the axle body stationarily.

Furthermore, FIG. 3 shows a perspective view of a wheel hub 115, on which a wheel bearing 116 is stationarily arranged. In the area of its end projecting from the wheel bearing 116, the wheel hub 115 forms a radially expanded wheel hub flange 117. This wheel hub flange 117 is used to receive a brake disk as well as a wheel of the motor vehicle during the normal operation of a motor vehicle, and this wheel hub flange 117 is provided with a plurality of internal threads 118 for this purpose in this exemplary embodiment.

The wheel hub 115 is mounted rotatably in the bearing housing 101 of the axle body 100 during the normal operation of the motor vehicle. The wheel bearing 116 is pressed for this purpose into the bearing bore 102 of the bearing housing 101. Such a completely mounted state of the wheel hub 115 in the bearing housing 111 of the axle body 100 is shown in FIG. 4 in a side view IV from FIG. 3.

As can be recognized from FIG. 4, an intermediate space 120, which extends radially to the flange hub 121 accommodated in the wheel bearing 116, is formed between the outer front ring surface 119 (cf. FIG. 3) of the bearing housing 101 and the wheel hub flange 117 in this mounted state. It can be recognized that the wheel hub 121 has a considerably smaller diameter than the wheel bearing 116 as well as the bearing housing 101. Furthermore, the broken line 122 in FIG. 4 indicates that the wheel bearing 116 is arranged axially recessed, i.e., set back in relation to the front ring surface 119 of the bearing housing 101, in the operating position being shown.

The peculiarity of the wheel hub 115 and of the wheel bearing 116 in this exemplary embodiment is that the wheel hub 115 has no central through hole. Furthermore, the wheel bearing 116 is closed on the rear side by a closing cover, which is not shown in greater detail. Because of this special embodiment of this axle design, it is not possible now to extract the wheel bearing 116 by means of a draw spindle passing through the wheel hub 116 from the bearing housing 101.

It is likewise impossible to press in the wheel bearing 116 via the wheel hub 115 with the conventional devices, because there would be a risk during this pressing-in operation that the wheel bearing 116 would be damaged by the extremely strong axial pressing forces. The device according to the present invention is intended specifically for this extraction and pressing in.

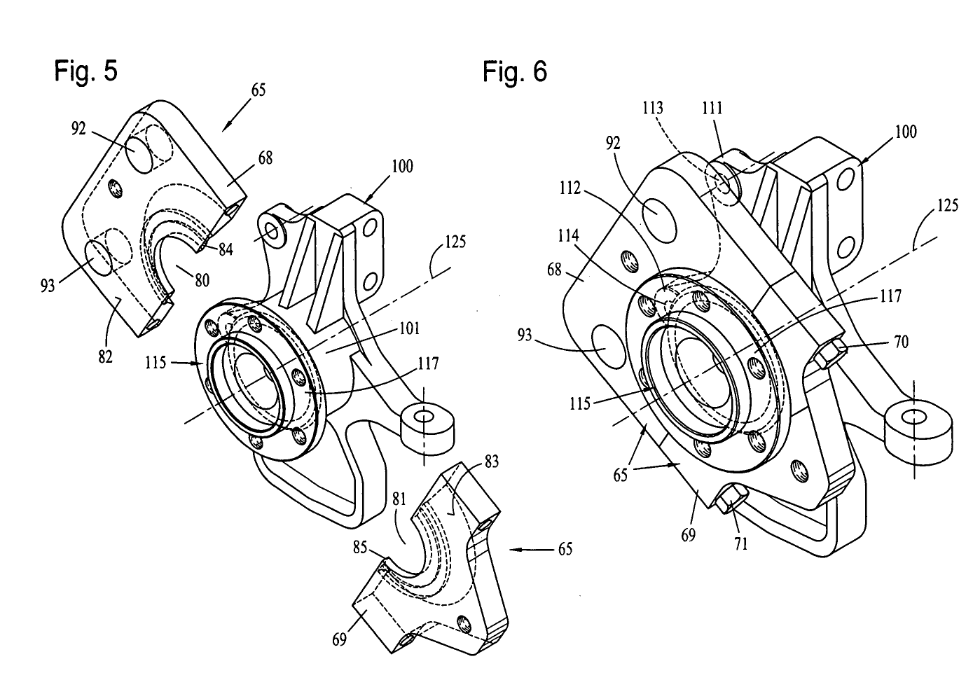

FIG. 5 shows for this a perspective view of the wheel hub 115, which is mounted in the axle body 100 and is mounted rotatably in the bearing housing 101 with its wheel bearing 116, which is not visible in FIG. 5. In this mounted position, the wheel hub 115 with its wheel hub flange 117 has an axial distance from the front ring surface 119 (indicated by broken line) of the wheel bearing housing 101.

The pressing plate 65 with its guide plate 68 is now inserted radially into the intermediate space 120 shown in FIG. 4 between the wheel hub flange 117 and the front ring surface 119. The guide plate 68 with its support surface 82 now comes flatly into contact with the rear side of the wheel hub flange 117. In this state of the guide plate 68, in which it is pushed into the intermediate space 120, the holding plate 69 can be mounted on the guide plate 68. This holding plate can likewise be pushed for this purpose radially into the intermediate space 120 between the wheel hub flange 117 and the front ring surface 119 of the bearing housing 101, diametrically opposite the guide plate 68.

The dimensions of both the semicircular opening 80 of the guide plate 68 as well as of the semicircular opening 81 of the holding plate 69 are selected now to be such that the flange hub 121 (FIG. 4) is received with a clearance in the through hole formed by these two openings 80 and 81, i.e., the pressing plate 65 arranged in the intermediate space 120 is freely rotatable both in relation to the bearing eye 101 and in relation to the wheel hub flange 117, as this can be seen especially in FIG. 6.

As a next step, the angular position of the pressing plate 65 with the through holes 92 and 93 is set about the axis of rotation 125 of the wheel hub 115 such that the through hole 92 is aligned coaxially with the mounting eye 111 and the through hole 93 is aligned coaxially with the bearing eye 112 of the axle body 100, as this can be recognized from FIG. 6. It can also be recognized from FIG. 6 that the holding plate 69 is stationarily in connection with the guide plate 68 via the two connecting screws 70 and 71, so that the guide plate 68 forms a stable, uniform pressing plate 65 together with the holding plate 69.

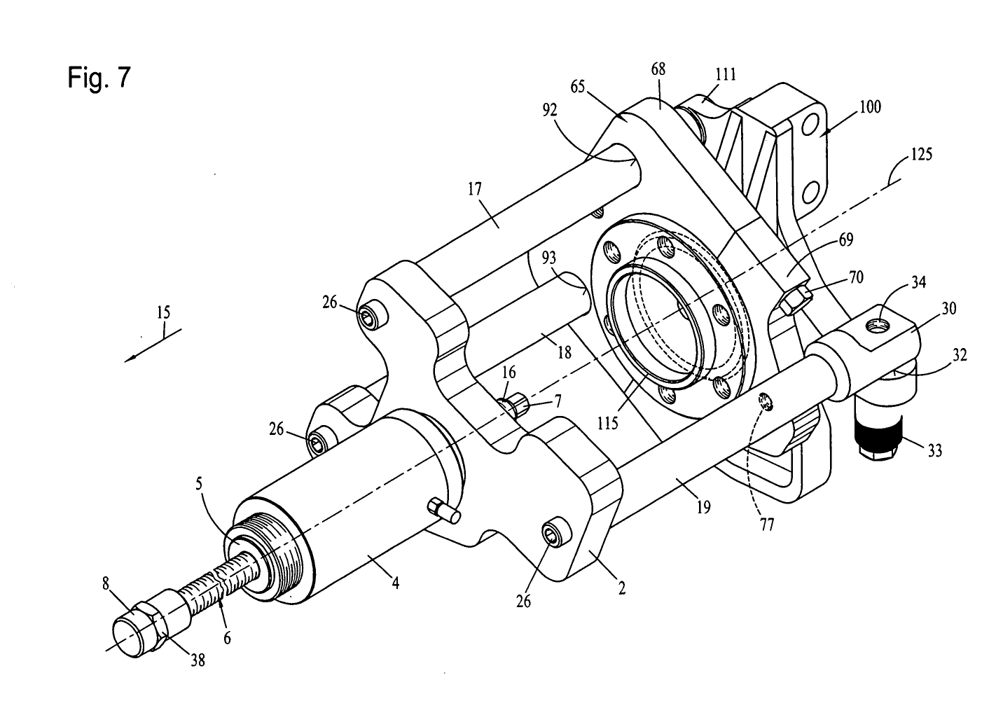

After the pressing plate 65 comprising the guide plate 68 and the holding plate 69 has been attached in the intermediate space 120 between the wheel hub flange 117 and the outer front ring surface 119 of the bearing housing 101, as this can be recognized from FIG. 6, the two support rods 17 and 18 can now be passed through the correspondingly associated through holes 92 and 93 of the guide plate 68 and brought into connection with the correspondingly arranged bearing eyes 111 and 112 via the mounting holes 113 and 114 thereof, which are visible in FIG. 3, as this can be recognized from FIG. 7 for the support rod 17 and for the bearing eye 111 of the axle body 100. The two fastening screws 29, which are not visible in FIG. 7, are provided now for the stationary mounting of the two support rods 17 and 18.

The support rod 19 with its mounting head 30 can subsequently be brought into connection with the bearing eye 109 of the axle body 100. The mounting head 30 is attached for this purpose, for example, with its lower mounting surface 32, to the bearing eye 109, and the locking screw 33 is passed through the through hole 110 of the bearing eye 109, which is seen in FIG. 3, and is caused to mesh with the internal thread 34 of the bearing head 30. Before the locking screw 33 is tightened, the support plate 2 with the support rods 17, 18 and 19 can be fastened on its sides located opposite the axle body 100. The mounting screws 26 are provided for this purpose, as this can be seen in FIG. 7.

After the support plate 2 has been mounted snugly on the three support rods 17, 18 and 19, the locking screw 33 can now be tightened, so that the support rods 17, 18 and 19 form a stationary unit together with the support plate 2 and the axle body 100. The approximately triangular shape of the holding plate 69 is selected here such, as this can be recognized especially from FIG. 7, that the holding plate 69 cannot collide with the support rod 19. In particular, the holding plate 69 can be removed from the axle body 100 after detaching or removing the two connecting screws 70 and 71 (only the connecting screw 70 can be recognized in FIG. 4), which will be explained once again later.

After the support plate 2 has now been brought stationarily into connection with the support rods 17, 18 and 19, the hydraulic cylinder 4 is brought now into connection with the support plate 2 via the adapter 11. In the completely mounted position shown in FIG. 4, the hydraulic cylinder 4 with its central pressing rod 6 extends coaxially with the axis of rotation 125 of the wheel hub 115. The hydraulic cylinder 4 is designed as a single-acting tubular piston cylinder in this exemplary embodiment, and it is used as a pulling device in its orientation shown in FIGS. 7 through 10 to extract the wheel bearing 116, which is seated on the wheel hub 115 and can be seen in FIG. 3.

In other words, when the hydraulic cylinder 4 is activated, its pressing piston 5 is moved in the direction of arrow 15. The pressing rod 6 with its adjusting thread 16 and its drive hexagon 7 passes here through the support plate 2 toward the wheel bearing 115. To make it possible to apply the pulling forces to the pressing plate 65, the coupling bridge 40 with the connecting screws 61 and 62 as well as with the two spacer sleeves 66 and 67 from FIG. 2 is provided. The arrangement of the support rod 17, 18 and 19 is selected here to be such that the coupling bridge 40 with its through hole 41 can be inserted between the support plate 2 and the wheel hub 115 in such a way that it extends coaxially with the axis of rotation 125.

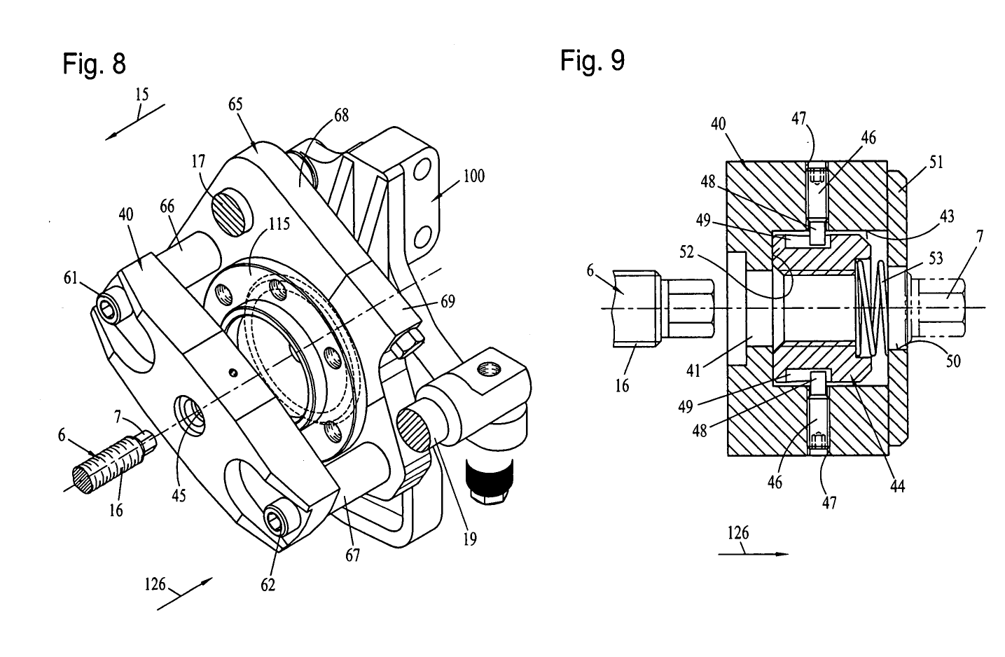

FIG. 8 shows a partial perspective view for this, in which the support plate 2 with the hydraulic cylinder 4 is not shown and the support rods 17 and 19 are shown as cut-away support rods for clarity's sake. The adjusting thread 16 of the pressing rod 6 as well as the drive hexagon 7 can be recognized from FIG. 8 in a partial perspective view.

In the state of the coupling bridge 40 in which it is attached to the pressing plate 65 and which is shown in FIG. 8, the two connecting screws 61 and 62 are screwed into the internal threads 76 and 77 of the guide plate 68 as well as of the holding plate 69, which [internal threads] can be correspondingly recognized from FIG. 7. The two spacer sleeves 66 and 67 are arranged between the coupling bridge 40 and the pressing plate 65 and between the guide plate 68 and the holding plate 69. The coupling bridge 40 is thus stationarily in connection with the pressing plate via the two connecting screws 61 and 62 as well as the spacer sleeves 66 and 67.

By rotating the pressing rod 6 by means of its pressing head 8 or the hexagon insert bit 38 thereof in the direction of arrow 126, the pressing rod 6 with its adjusting thread 16 will mesh with the internal thread 45 of the pulling sleeve 44 inserted into the coupling bridge 40. The pulling sleeve 44 is not shown explicitly in FIG. 8 for reasons of clarity. Since the threads of the adjusting thread 16 do not usually agree axially with the threads of the internal thread 45 of the pulling sleeve 44, the pulling sleeve 44 is received axially adjustably in the coupling bridge 40. FIG. 9 shows a vertical cross section through the coupling bridge 40 for this.

It can be recognized from FIG. 9 that the pulling sleeve 44 is inserted into the hollow 43 of the coupling bridge 40. The pulling sleeve 44 has a radial clearance in relation to the hollow 43, so that it is axially adjustable. The two stud screws 46 are screwed into the corresponding, radially extending through threads 47 of the coupling bridge 40 and protrude radially into the hollow 43 of the coupling bridge 40. The two coupling pins 48 of the stud screws 46 now mesh with the diametrically opposite longitudinal slots 49 of the pulling sleeve 44. It can be recognized that the longitudinal slots 49 are arranged such and have such an axial length that the pulling sleeve 44 can be adjusted by a limited extent from the initial position shown in FIG. 9 in the direction of arrow 126. In the shown initial position of the pulling sleeve 44, the latter is flatly in contact with the front ring wall 52 formed by the hollow 43. The pulling sleeve 44 is held by the axial compression sleeve 52 in this initial position, which is shown in FIG. 9. The hollow 43 is secured in this mounted state of the pulling sleeve 44 by the closing cover 51 mounted on the coupling bridge 40 on the outside.

If the pressing rod 6 with its adjusting thread 16 is now screwed in the direction of arrow 126 through the through hole 41 of the coupling bridge 40, it will enter the axial area of the internal thread 45 of the pulling sleeve 44 with its adjusting thread after a certain path of adjustment. Since the threads of the adjusting thread 16 do not usually agree with the threads of the internal thread 45 in the axial direction, the pulling sleeve 44 is displaced in the direction of arrow 126 during the further feed motion of the pressing rod 16 until the threads of the adjusting thread 16 of the pressing rod 6 will agree axially with the threads of the internal thread 45 of the pulling sleeve 44. The adjusting thread 16 is subsequently screwed into the internal thread 45 of the pulling sleeve 44 during the further rotation of the pressing rod 6 in the direction of arrow 126.

Provisions may now be made for the pressing rod 6 to be adjusted into the position of the drive hexagon 7 shown by phantom lines in FIG. 9 by the pulling sleeve 44, the axial compression spring 53 as well as by the through hole 50 of the closing cover 51. After this position has been reached, the hydraulic cylinder 4 can now be activated, so that the pressing piston 5 moves together with the pressing rod 6 in the direction of arrow 15 in FIG. 7 and the pulling sleeve 44 will again move into the initial position shown in FIG. 9.

The pressing rod 6 is now in axial pulling connection with the coupling bridge 40 via its adjusting thread 16 and the pulling sleeve 44, so that the coupling bridge 40 and thus also the pressing plate 65 are pulled in the direction of arrow 15 during the further activation of the hydraulic cylinder 4. The guide plate 68 slides along the two support rods 17 and 18 during this adjusting motion, and the wheel hub 115 meshing with the pressing plate 65 is pulled at the same time out of the axle body 100 or the bearing eye 101 thereof together with the wheel bearing 116, which is not recognizable in FIGS. 7 and 8, during this adjusting motion in the direction of arrow 15.

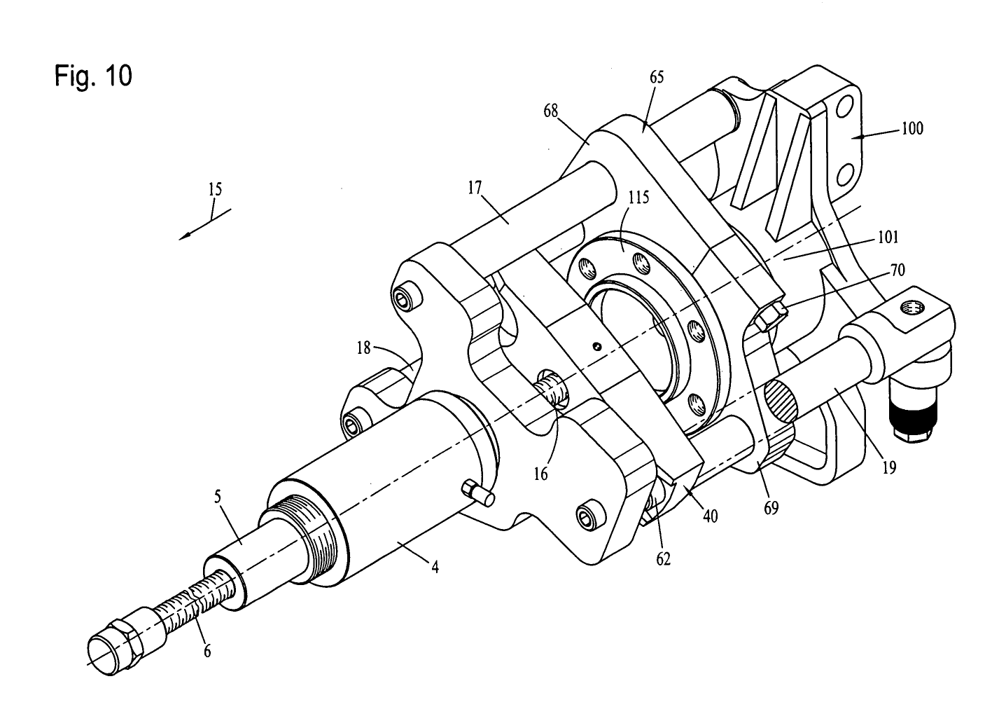

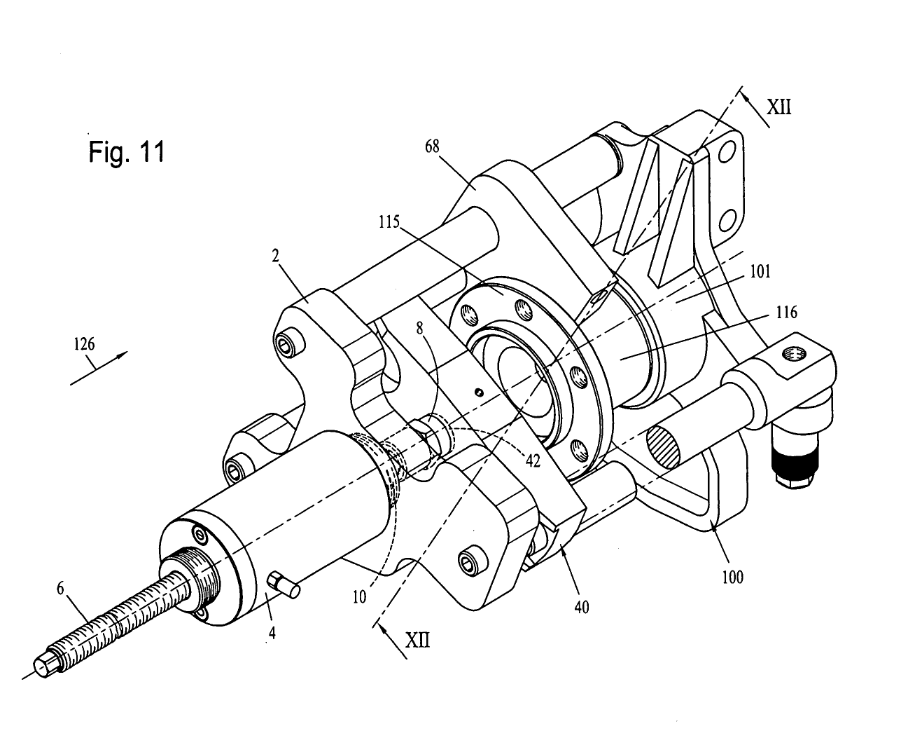

The end of this extraction operation is shown in FIG. 10. It can be recognized that at the end of the adjusting motion, the pressing piston 5 of the hydraulic cylinder 4 has moved out of this in the direction of arrow 15 and the coupling bridge 40 has thus been likewise pulled in the same direction via the adjusting thread 16 of the pressing rod 6. The pressing plate 65 with its guide plate 68 as well as with its holding plate 69 has correspondingly also been pulled in this direction. The wheel bearing, which is not recognizable in FIG. 10, is now disengaged from the bearing housing 101 of the axle body 100.

The two connecting screws 70 and 71 (only one is recognizable in FIG. 1) can now be removed. After the connecting screw 62 has been removed as well, the holding plate 69 can then be removed from the wheel hub 115. The shape of the holding plate 69, as it is apparent from FIG. 10, is selected to be such that the holding plate 69 can be removed downward between the two tie rods 18 and 19. Neither of the tie rods 18 or 19 needs to be removed for this removal of the holding plate 69.

After the holding plate 69 has been removed, the wheel hub 115 can now be removed from the guide plate 68 together with the wheel bearing 116. The wheel hub 115 is subsequently provided with a new wheel bearing and can again be pressed into the bearing housing 101 of the axle body 100 by means of the device according to the present invention.

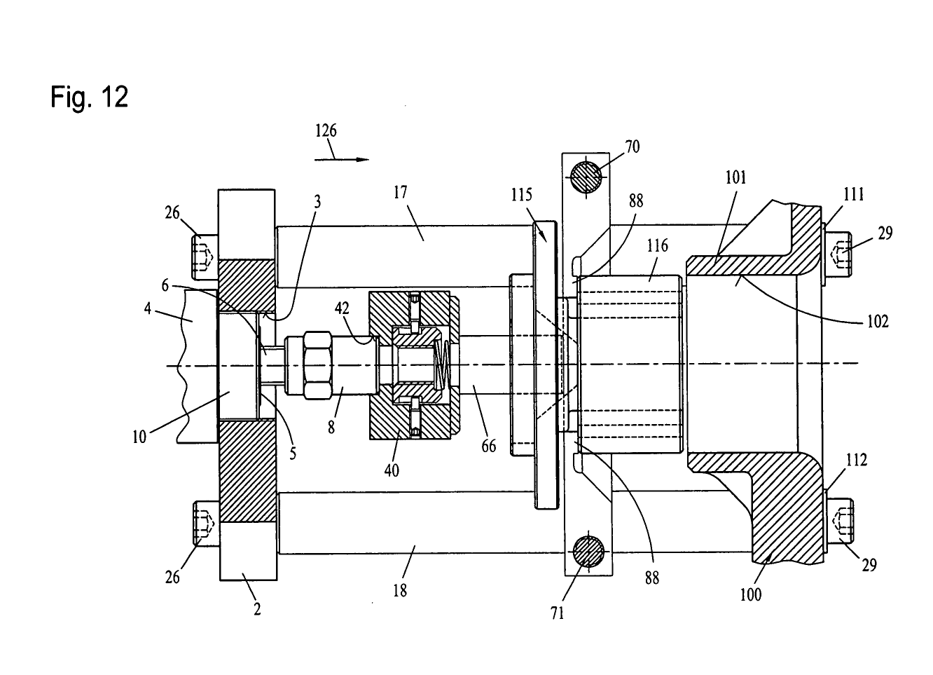

The wheel hub 115 with the wheel bearing 116 is first caused to mesh for this purpose with the guide plate 68, as this can be seen in FIG. 11. The holding plate 69 can subsequently be mounted again stationarily at the guide plate 68. The guide plate 68 and the holding plate 69 now mesh with their two support flanges 84 and 85 in the intermediate space 120 between the wheel hub flange 117 as well as the wheel bearing 116. FIG. 12 shows this meshing as an example, FIG. 12 showing a partial section XII-XII from FIG. 11, which section extends in the parting plane of the guide plate 68 and the holding plate 69.

Furthermore, it can be seen in FIG. 11 that the hydraulic cylinder 4 is mounted on the support plate 2 in the orientation in which it is rotated by 180°. It is screwed for this purpose with its external thread 10 into the support plate 2. As was mentioned above, another, suitable connection, especially a quick-acting closure, may also be provided here between the hydraulic cylinder 4 and the support plate 2. The pressing head 8 can be caused by this rotation of the pressing rod 6 to mesh with the hollow 42 of the coupling bridge 40. When the hydraulic cylinder 4 is activated, its pressing piston, which is not recognizable in FIG. 11, is adjusted together with the pressing rod 6 in the direction of arrow 126, so that a corresponding adjusting motion of the coupling bridge 40 is brought about hereby as well. If the holding plate 69 (not shown in FIG. 11) is mounted at the guide plate 68, the wheel hub 115 together with the wheel bearing 116 is pressed by the adjusting motion into the bearing housing 101 of the axle body 100.

FIG. 12 shows, as was already mentioned above, the initial position in a partial section before pressing in from FIG. 11. It can be recognized that the wheel bearing 116 is arranged directly in front of the bearing bore 102 of the bearing housing 101. Due to the guide plate 68 being guided at the two support struts 17 and 18, only a slight alignment of the wheel hub 115 together with the wheel bearing 116 is now necessary, because the wheel hub 115 is received in the openings 80 and 81 of the guide plate 68 and the holding plate 69 with a small radial clearance. In particular, the guide plate 68 can be attached manually to the bearing housing together with the holding plate 69 and the mounted wheel hub 115 with the wheel bearing 116. Due to the guide plate being guided at the two support struts 17 and 18, the wheel bearing 116 remains in its position in which it is attached to the bearing housing 101.

Furthermore, it can be recognized from FIG. 12 that the pressing head 8 of the pressing rod 6 is received in the radially expanded hollow 42 of the coupling bridge 40. The two bearing eyes 111 and 112 of the axle body 100, on which the two support rods 17 and 18 are stationarily mounted by means of the fastening screws 29, can also be recognized in FIG. 12. Furthermore, the support rods 17 and 18 are mounted stationarily on the support plate 2 by means of the mounting screws 26. It can also be recognized from FIG. 12 that the hydraulic cylinder 4 is screwed directly into the internal thread 3 of the support plate 2 by means of its coupling thread 10.

It is easy to imagine now that when the hydraulic cylinder 4 is activated, its pressing piston 5 is adjusted in the direction of arrow 126, so that the wheel bearing 116 is pressed into the bearing bore 102 of the bearing housing 101 as a result via the guide plate 68 and the holding plate, which cannot be recognized in FIG. 12. The wheel bearing 116 is supported for this purpose at the axially projecting support struts 88 (and 89) of the guide plate 68 (as well as of the holding plate 69), but only the support web 88 of the guide plate 68 is recognizable in FIG. 12.

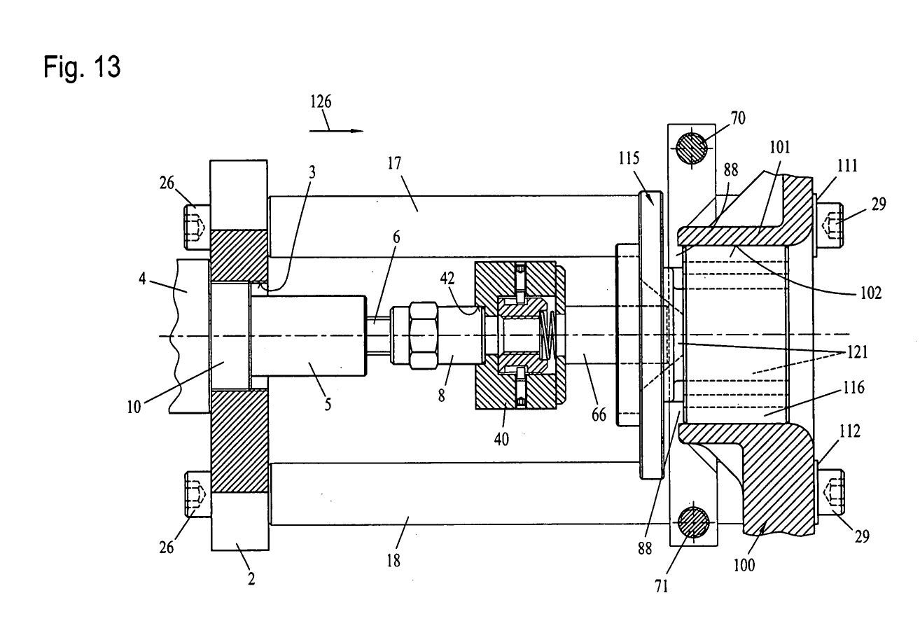

Due to this design of the support web 88 and the support web 89, the wheel bearing 116 can be pressed into the bearing bore 102 of the bearing housing 101 of the axle body 100 in a recessed manner, as this can be recognized from FIG. 13. It is seen that the pressing piston 5 of the hydraulic cylinder 4 has moved out of the hydraulic cylinder in the direction of arrow 126. Thus, the wheel hub 115 together with the wheel bearing 116 is again in the pressed-in position shown in FIG. 7.

It becomes clear that the wheel bearing 116 together with the wheel hub 115 can be replaced, as was described, by means of the device according to the present invention in a very simple manner.

This device according to the present invention can be advantageously used in cases in which no pulling or pressing rod can be passed through the wheel hub 115 or through the wheel bearing 116. In particular, the support rods 17, 18 and 19, by means of which the support plate 2 can be fixed at the axle body in an axially stationary manner, as this can be recognized especially from FIG. 7, are provided for this purpose in an advantageous manner. Due to this design, it is possible to extract the wheel hub 115 together with the wheel bearing 116 from the bearing housing 101 of the axle body 100 and to press it in again with the pressing plate 65 comprising the guide plate 68 and the holding plate 69 in a simple manner.

Recessed arrangement of the wheel bearing 116 in the bearing housing 101 can be achieved because of the two support webs 88 and 89 of the support flanges 84 and 85 of the guide plate 68 as well as of the holding plate 69. If recessed arrangement is not provided for, a guide plate and a holding plate, which have a flat support flange 84 and 85, respectively, without the respective axially projecting support webs 88 and 89, may also be provided.

While specific embodiments of the invention have been shown and described in detail to illustrate the application of the principles of the invention, it will be understood that the invention may be embodied otherwise without departing from such principles.

What is claimed is:

1. A device for extracting and pressing in a wheel bearing, which can be accommodated in a bearing bore of a bearing housing of an axle body, via which wheel bearing a wheel hub having a wheel hub flange is mounted rotatably in the bearing housing, the device comprising:
a pressing means;
a pressing plate arranged with a support flange between the wheel hub and the axle body, wherein the axle body is provided with a plurality of bearing eyes, which are used to mount additional axle components or a caliper, said pressing plate forming a guide plate with an approximately semicircular opening radially limited by said support flange, and said guide plate with said support flange can be pushed into an intermediate space between the wheel hub flange of the wheel hub and the bearing housing of the axle body such that said support flange is supported at the wheel hub flange on the rear side during an extraction operation and is axially supported at the wheel bearing during a pressing-in operation.

2. A device in accordance with claim 1, wherein said support flange of said guide plate is provided in an area of a radial inner edge with an axially projecting support web, with which the wheel bearing can be pressed into the bearing housing in a recessed manner.

3. A device in accordance with claim 1, further comprising:
a holding plate associated with the guide plate, said holding plate being detachably fastenable to the guide plate, said holding plate having an approximately semicircular opening, which is radially limited by a support flange, said holding plate with said support flange be pushable into the intermediate space between the wheel hub flange of the wheel hub and the bearing housing of the axle body such that said support flange is supported at the wheel hub flange on the rear side during the extraction operation and is supported axially at the wheel bearing during the pressing-in operation.

4. A device in accordance with claim 3, wherein said support flange of the holding plate is provided in the area of said radial inner edge with an axially projecting support web, with which the wheel bearing can be pressed into the bearing housing in a recessed manner.

5. A device in accordance with claim 1, wherein said pressing means has a support plate, which can be stationarily attached to the bearing eyes of the axle body by means of support rods, and that said pressing means has a pressing rod, which is adjustable axially in relation to said support plate and which can be coupled with said pressing plate in an axially stationary manner.

6. A device in accordance with claim 1, wherein a coupling bridge, which is coupled with said pressing rod in an axially stationary manner to extract and press in the wheel bearing, is provided for the axial adjustment of said pressing plate.

7. A device in accordance with claim 6, wherein said pressing rod is part of a hydraulic cylinder, which replaceably meshes with said support plate in an axially stationary manner, and said pressing rod has an adjusting thread, via which said pressing rod is received axially adjustably in an axially adjustable pressing piston of the hydraulic cylinder.

8. A device in accordance with claim 7, wherein said pressing rod means can be brought into pulling connection with said coupling bridge with said adjusting thread to extract the wheel hub together with the wheel bearing.

9. A device in accordance with claim 8, wherein to establish the pulling connection, said coupling bridge has an internal thread, which is part of a pulling sleeve, which is arranged in a hollow of said coupling bridge and is axially supported at an inner front ring wall of the hollow during the extraction operation.

10. A device in accordance with claim 9, wherein said pulling sleeve is held axially adjustably and nonrotatably via coupling pins protruding radially into said hollow of said coupling bridge, and said coupling pins radially mesh with said adjusting slots of the pulling sleeve.

11. A device in accordance with claim 8, wherein said pulling sleeve in said hollow is pressed against a front ring wall by an axial compression spring, and said axial compression spring is axially supported on a closing cover, which is screwed on the outside detachably onto said coupling bridge in the area of the hollow.

12. A device in accordance with claim 5, wherein said pressing rod has an end area with a pressing head, via which said pressing,rod can be brought into pressing connection with said coupling bridge to press in the wheel bearing.

13. A device in accordance with claim 12, wherein said pressing head is provided with a hexagon insert bit.

14. A device in accordance with claim 6, wherein spacer sleeves as well as connecting screws are provided for the stationary coupling of said pressing plate comprising said guide plate and said holding plate with said coupling bridge.

15. A device in accordance with claim 5, wherein said pressing plate is provided with two guide holes, via which said pressing plate is guided concentrically with the bearing housing and the wheel hub at two of the support rods in an axially adjustable manner.

16. A device in accordance with claim 7, wherein said hydraulic cylinder is designed in the form of a tubular piston cylinder and is provided at two axial ends thereof with coupling elements, with which the hydraulic cylinder can be caused to mesh with the support plate in different orientations in a stationary manner to apply pulling or pushing forces as desired.
